(19) United States
(12) Patent Application Publication
(10) Pub. No.: US 2002/0187230 A1
(43) Pub. Date: Dec. 12, 2002

(54) Methods of reducing friability of cereal products, potato chips, and freeze-dried foods, of increasing bowl life of cereal products, and of delaying rancidity of nuts

(76) Inventors: John M. Krochta, Davis, CA (US); Soo-Yeun Lee, Davis, CA (US); Thomas A. Trezza, Dallas, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/879,794

(22) Filed: Jun. 11, 2001

(51) Int. Cl. A23L 1/10

(52) U.S. Cl. 426/460

(57) ABSTRACT

The invention provides methods of reducing the friability of food items such as cereal products (including ready to eat cereals and corn and tortilla chips), of potato chips, and of freeze-dried foods. The methods involve contacting the food item with water and then drying the food item to approximately its original water content. The water may be applied by any convenient means so long as it does not cause overhydration of the food item. The invention further provides methods of delaying the development of rancidity in nuts. The methods comprise contacting the nuts with water. In preferred forms, the methods comprise causing mild abrasion of the nuts to facilitate hydration.

### CROSS-REFERENCES TO RELATED APPLICATIONS

This application is related to a co-owned application, attorney docket no. 023070-114120US, filed on the same date.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The current invention relates to the perceived attractiveness and quality of food products.

According to recent surveys, some forty (40%) of persons eating breakfast in the United States choose a ready to eat (“RTE”), or “cold” breakfast cereal. Such cereal products are so familiar that they are commonly referred to as “cereals” by the public. RTE cereals are typically in the form of nuggets, extruded shapes, some of which can be fanciful, or flakes, such as the familiar corn flake. They are typically eaten with milk and, once the milk has been added, if the cereal is not eaten quickly, it quickly becomes soggy and less attractive to the consumer. The length of time before a cereal becomes soggy is known as its “bowl life,” and various means are used to extend bowl life. One method used to extend bowl life is to apply a starch-based film. Specialty starches, such as high-amylose starch, are used for this purpose. It would be desirable to develop simple methods to extend the bowl life of RTE cereals.

Cereal products, and especially thin cereal products such as flaked RTE cereals and the familiar corn chip and tortilla chip, are also prone to breakage during shipping and handling. Such products are sold by weight, rather than volume, but breakage of the product can make it appear that the package contains less than the stated amount of product. Further, since people tend not to eat small pieces of corn and tortilla chips, such breakage tends to render a portion of the product unusable. It would be desirable to reduce the breakage of cereal products such as flaked RTE cereals, corn chips, tortilla chips, and other chip products.

Peanuts and nuts are another popular food choice. One problem with peanuts and nuts is limited shelf life due to the oxidation of oils present in the peanut or nut. This oxidation is perceived by the consumer as “rancidity,” and makes the peanut or nut less palatable. To reduce oxidation, peanuts and nuts are usually sold in sealed plastic bags or airtight tins. Plastic bags tend, however, to allow some diffusion of oxygen, with a consequent degradation of palatability over time. And even peanuts and nuts in fully airtight packaging degrade once the seal is broken, requiring the peanuts or nuts to be eaten within a reasonably short period of time for best flavor. Accordingly, it would be desirable to lengthen the time before peanuts or nuts, or both, develop rancidity.

### BRIEF SUMMARY OF THE INVENTION

The present invention provides a method for improving a cereal product, said method comprising contacting said cereal product with substantially pure water or with steam, and drying said cereal product to its original water content, thereby improving reducing the cereal product. The contacting can be by any convenient means, so long as the cereal product is not overhydrated. In preferred embodiments, the contacting is by spraying water or misting the cereal product. The water should be at least about 90% pure, and may be any integer more pure (such as 91%, 92% etc.), with more highly pure water being preferred. The water may be cold, warm or hot. In preferred embodiments, the water temperature is between about 50 and 150°. Water of about 70-125° F. is more preferred and water of about 80 to about 100° F. is even more preferred.

The cereal product may be a ready-to-eat breakfast cereal. In some embodiments, the breakfast cereal is a flaked cereal, and may be, for example, selected from the group consisting of a corn flake, a wheat flake, an oat flake, a barley flake, and a rice flake.

The cereal product may also be a fried or baked cereal chip, such as a corn chip or a tortilla chip.

The improvement may be an increase in “bowl life” of a ready-to-eat (“RTE”) breakfast cereal. The RTE cereal can be a flake, an extruded cereal piece, a shredded cereal, and a granular or nugget cereal. In especially preferred embodiments, the RTE cereal is a flake.

In another group of embodiments, the invention provides a method for reducing the friability of a potato chip or of a freeze-dried food, such as chicken “dice” or a freeze-dried fruit, said method comprising contacting said potato chip or freeze-dried food with water, and drying said potato chip or freeze-dried food to its original water content, thereby reducing its friability. The contacting can be by any convenient means, so long as the chip or freeze dried food is not overhydrated. In preferred embodiments, the contacting is by spraying or misting water on the chip or food. The water may be cold, warm or hot. In preferred embodiments, the water temperature is between about 50-and 150°. Water of about 70-125° F. is more preferred and water of about 80 to about 100° F. is even more preferred.

In yet another aspect, the invention provides a method for increasing shelf life of a nut, said method comprising contacting said nut with water, and drying said nut to its original water content, thereby increasing its shelf life. The contacting with water can be by any convenient means, including spraying, pouring, or immersing the nut in water. Preferably, the nut is subjected to mild abrasion in the presence of said water. In preferred embodiments, the mild abrasion is caused by contacting the nut with a second nut. In one group of embodiments, the nut is moved against the second nut by placing the nuts in a movable container and moving, shaking, rotating, or vibrating said container. In another set of embodiments, the nut may be moved against the second nut by placing the nuts on a surface and agitating the surface or the nuts. The nuts may be of the same or different types. In some preferred embodiments, the nut is a peanut. The nut may also be selected from the group consisting of almond, cashew, walnut, hazelnut, pecan, macadamia, pistachio, Brazil nut, and filbert.

### DETAILED DESCRIPTION OF THE INVENTION

Introduction

Surprisingly, it has been found that contacting foods such as (a) cereal products such as cold cereals, corn chips and tortilla chips, (b) potato chips, and (c) freeze-dried foods, to water sufficient to wet the surface but not to soak into the interior of the product, and then permitting them to dry, reduces the susceptibility of the foods to breakage. Perhaps more surprisingly, contacting cereals with water and then permitting them to dry also increases the resistance of the cereals to becoming soggy when milk is later added, and contacting corn chips or tortilla chips with water and then permitting them to dry delays the development of sogginess if they are later placed in conditions where liquids can migrate into them, as when they are placed in a dip or under melted cheese in dishes such as nachos. Finally, and equally surprisingly, it has been discovered that peanuts and nuts contacted with water and allowed to dry stay fresh longer than peanuts and nuts that have not been treated. All of these discoveries are discussed in more detail below.

Definitions

Unless otherwise defined, terms used herein have their ordinary meaning as used in the art.

As used herein, “cereal product” refers to products other than breads and “hot cereals,” that are made with cereal grains. “Hot cereals” such as oatmeal, farina, and grits generally require cooking by the consumer and are less popular than are the so-called “cold cereals,” that are “ready-to-eat.” Ready to eat (“RTE”) cereals are encompassed by the cereal products that can be successfully treated by the methods of the invention.

As used herein, the term “cereal”, without additional description, refers to a cold, or RTE, cereal.

“Bowl life” refers to the period of time between adding milk to a bowl of cereal and the point at which the cereal becomes unappetizingly soggy.

As used herein, the term “nut” refers to both nuts and peanuts, unless otherwise required by context.

With reference to a nut, “shelf life” refers to the period of time before the nut exhibits rancidity. Conveniently, rancidity can be measured by the development of hexanal.

As used herein, “friability” refers to the tendency of a composition or article of manufacture to crumble or to break into pieces.

As used herein, “freeze-dried” refers to a process in which a food is frozen and then dried, typically under a vacuum, so that the water sublimates to water vapor without going through a liquid phase.

Unless otherwise specified, as used herein the terms “pure water” or “substantially pure water” mean water which does not contain more than a specified percentage of substances not normally present in municipal (“tap”) or bottled water. Municipal or bottled water is not chemically pure and may contain dissolved gases, such as carbon dioxide, as well as minerals present either naturally or, like fluoride, through addition by the water authority. Water that is, for example, 90% pure or substantially pure does not contain more than 10% (by weight) of dissolved substances not normally present in tap or bottled water or 10% (by volume) of non-dissolved material. Purer water is more preferred than less pure water in the methods of the invention, with each of the following percentages of purity being more preferred than the one that precedes it: 9, 8, 7, 6, 5, 4, 3, 2, and 1%.

As used herein, the phrase “drying to its original water content” means to restore the article or item in question to within ±10% of its original water content. More preferably, it means to restore the article or item in question to ±5% of its original water content.

Cereal Products, Breakage and Bowl Life

Cereal products such as breakfast corn flakes, corn chips, and tortilla chips, 110 have a tendency to break and crumble. This propensity is known in the art as “friability.” In relevant part, the present invention relates to the discovery that friability of cereal products prone to breakage can be reduced by contacting the cereal product with water sufficient to hydrate the exterior surface, and then permitting the cereal product to dry. While all cereal products can benefit from this method, the effect is most noticeable with regard to thin cereal products, such as flake breakfast cereals, in which the thickness of the flake is much less than the height and length. Without wishing to be bound by theory, it is believed that the surface of the cereal product comprises a number of pores and that hydration of the surface of the product causes the surface to swell, closing or reducing the pores, and increasing the structural strength. Exemplary tests of the method on breakfast cereal flakes have shown decreases of up to 70% in the amount of cereal that is broken during the test compared to flakes of the same cereal that have not undergo treatment with the method.

Ready to eat breakfast cereals can generally be classified into one of four types: flaked, puffed, shredded, or granular. The methods of the invention are particularly useful with flakes cereals such as corn flakes and wheat flakes, whose thinness makes them especially fragile. Some cereals are however produced in fanciful shapes, such as cartoon characters, wheels, “honeycombs” or the like, or in geometric shapes, such as circles and spheres. Many of these shaped cereals (which will be referred to herein as “extruded cereals”) are susceptible to breakage and can be treated by the methods of the invention so long as they have a porous surface. Additionally, the less fragile types of cereals can benefit from the improved “bowl life” aspects of the invention, as discussed further below, so long as they do not have a glazed or otherwise non-porous surface.

Flaked cereals typically are composed of cooked corn, wheat, rice, oat, barley, or other grains that are cooked and then pressed into flakes between rollers. The soft flakes then proceed to toasting ovens, in which the flakes are dehydrated, toasted and blistered.

Following this toasting, the flakes are often sprayed with starches or sugar solutions to help adhere particulates such as fruit bits, fruit powders, flavorings, or nut pieces. Kuntz. L. A., www.foodproductdesign.com/archive/1998/0498CS.html. Sugar solutions are also used to introduce vitamins and antioxidants and act as an oxygen barrier. Id. It is recommended that the starches or sugar solutions are applied in a 25% to 30% solution, id., and sucrose solutions used to apply vitamins should constitute at least 10% of the vitamin spray formula and is generally used in the 15 to 25% range. Id.

Surprisingly, it has now been discovered that the application of water itself, without the addition of costly specialty starches, sugars, and the like, acts to reduce the friability of a cereal product or chip, and to increase bowl life. Until the present discovery, any favorable effect from the contacting with water has been assumed to be the result of the starches, sugars or other substances added to the water, and the effect of the water has been unrecognized due to the presence of the additional substances.

It is understood that the cereal products and potato chips discussed herein may be contacted with water at various points during the manufacturing process. For example, cereal flours may be mixed with water and the resulting mixture may be cooked to form the cereal product. The contacting with water and subsequent drying contemplated by the present invention occur after the cereal chip or cereal product has been fully cooked as a last treatment, typically prior to mixing with other ingredients, such as raisins, or other types of cereal, or packaging. It should be noted that if the cereal is still warm from the cooking process, any residual heat will help evaporate excess water from the cereal after the contacting. Thus, contacting with water while the cereal is still warm may offer some speed and energy efficiencies.

In the case where several different types of cereal are mixed together, as in flakes of two types or where a flake cereal and a granular or “nugget” type cereal are mixed together to provide a contrast, one or more of the cereal types may be treated before the cereals are mixed, or the cereals may be mixed together and then contacted with water. If other ingredients (such as nuts or raisins) will be dried along with the cereal and are otherwise compatible with brief contact with water and subsequent drying (for example, they will not dissolve in the water nor be adversely affected by warmed air if used to dry the cereal), they can be contacted with the water and dried along with the cereal.

It should be noted that the methods of the invention will be useful on cereal products that have a porous surface. Thus, if the cereal has been coated with a sugar glaze the methods will be less useful. The contacting with water should also not be so great as to dissolve or wash off desirable ingredients adhered to the cereal in a previous processing step.

The discovery that contacting cereal products with water reduces friability enhances the attractiveness of the product to the consumer. For any given amount of handling and shaking, treatment according to the methods of the invention provide a larger percentage of unbroken product compared to a like untreated cereal product undergoing the same handling. Preferably, the friability of the product is decreased by at least 5% compared to the untreated product, more preferably 10%, and, with increasing degrees of preference, by 20%. 30%, 40%, 50%, 60%, or more. In tests on flake cereals treated by the methods of the invention, friability has been observed to be decreased by approximately 70%.

The method of the invention also reduces the friability of other cereal products. In particular, products such as corn chips and tortilla chips (both baked and fried) suffer from breakage and can have their friability reduced by the methods of the invention. These products are not typically sprayed to add vitamins or to adhere particulates such as nuts to them, and accordingly will show significant reductions in friability compared to conventionally produced products. Other products with lower ratios of thickness compared to their height and width can also be treated by the methods herein. They tend, however, to be less fragile than flake and chip forms and will show less dramatic improvement in friability compared to similar, but untreated, products.

Friability can be tested by any method known in the art. Typically, a measured amount of the treated breakfast cereal, chip, or other cereal product is placed in a wire or other container and shaken, vibrated or rotated for a measured period of time. The portion of the product that is unbroken is separated from that which has broken off or become powder and weighed, and compared to the amount left of a like amount of an untreated product subjected to the same treatment. Conveniently, friability can be measured by a commercial device designed for the purpose, such as a Vanderkamp Friabilator model 10805 drum type 10811 (Vankel Industries, Edison N.J.). The determination can also be made using a standard test such as Standard D441-45, developed by the American Society for Testing and Materials (“ASTM,” West Conshohocken, Pa.), which test was developed for other purposes but is also used for food products.

Cereals tend to become soggy upon the addition of milk, and eventually become mushy, a condition consumers often find unappealing. The length of time before a given cereal becomes mushy is considered to be its “bowl life.” As note above, starches such as high amylose starch are added to cereals to improve their bowl life. Cereals treated by the methods of the present invention exhibit improved bowl life. Without wishing to be bound by theory, it is believed that pores left on the surface of the product by normal processing permit access to the interior of the product and decrease its bowl life, whereas the methods of the invention close or reduce the size of the pores, slowing the entrance of the milk and thus lengthening the time before the product becomes soggy. Practice of the invention therefore permits manufacturers of cereal products to avoid the cost and inconvenience of purchasing, handling and storing high amylose starch and other specialty starches. It should be noted that this aspect of the invention is helpful in improving the characteristics of cereals shaped as wheels, circles, spheres and other shapes, so long as they have a porous exterior.

Moreover, while corn chips and tortilla chips are not generally placed in a bowl with milk, as are breakfast RTE cereals, they are placed in contact with melted cheese, salsa, and other liquid-containing ingredients that cause undesirable sogginess in the chips. For example, corn or tortilla chips are typically used as the base for melted cheese, salsa, and other condiments in nachos, and often become too soggy from absorbed liquid to be eaten conveniently by hand. Chips treated by the methods of the invention will take longer to become soggy, and therefore retain their convenience and attractiveness to the consumer longer than will untreated chips.

Potato Chips

Like cereal products, potato chips have surface pores that can be reduced in size by contacting with water after processing. It is therefore expected that the friability of potato chips can be reduced by the methods of the invention. Additionally, while potato chips are not generally placed in a bowl with milk, as are breakfast RTE cereals, they are placed in contact with liquid-containing ingredients in casseroles and when used to scoop up dips. These liquid-containing ingredients can cause undesirable sogginess in the chips. Chips treated by the methods of the invention will take longer to become soggy, and therefore retain their convenience and attractiveness to the consumer longer than will untreated chips. In preferred embodiments, the potato chips are made from reconstituted potato flour rather than as fried slices of whole potatoes.

Freeze-Dried Foods

Foods are frequently freeze-dried to allow for stable storage without refrigeration. For example, fruits, such as strawberries are freeze dried and added to breakfast cereals. Meats are also freeze dried. Chicken is generally cooked and freeze dried in the form of small cubes (known as “chicken dice”) for use in soups. Additionally, foods are freeze-dried to make them lighter for backpacking and other uses in which the food may have to be carried for some distance.

Foods that have been freeze-dried tend to become quite porous and brittle, whereas products that have been air dried tend to collapse to a tougher, drier state. Freeze-dried foods are therefore susceptible to breakage in packaging, handling and shipping, often resulting in a considerable amount of the freeze-dried food being reduced to a powder or dust at the bottom of the package. This friability of freeze-dried foods can be reduced by the methods of the invention.

Contacting Cereal Products, Potato Chips, or Freeze Dried Food with Water

The contacting of the cereal products, potato chips, or freeze-dried food should be sufficient to wet the surface and preferably covers the surface of the item evenly. The actual contacting can be quite brief, and in fact should be brief since what is desired it to hydrate the surface of the product without significant hydration of the interior. The amount of water used can be, for example, 1 to 100% of the weight of the cereal, chip, or freeze-dried food, with about 5-10% being preferred. Significant hydration of the interior has occurred if the product, chip, or food “collapses,” that is, it becomes soft and visibly loses rigidity or flattens. Usually, one to a few seconds will be sufficient to wet the cereal, product, chip, or freeze-dried food. The correct amount of water and time of application is easily determined empirically and will depend in part on the porosity of the particular product, chip or freeze-dried food treated, the temperature of the water and the method of contacting.

In preferred forms, the water is sprayed on the product, chip, or freeze-dried food. Misting, which is the use of an extremely fine spray, may also be used and permits somewhat finer control since less water is applied per unit time. Immersion or pouring water over the cereal product potato chip, or freeze-dried food, by contrast, is less preferred because it is harder to avoid overhydrating the product. In general, as soon as the surface of the flake, chip, freeze-dried food, or other product is wetted, it is desirable to start drying it.

Water of any temperature may be used, as may steam. Very hot water and steam are, however, less preferred since they will penetrate flakes, chips, or freeze-dried food very quickly and it is accordingly somewhat more difficult to avoid overhydration. Warm water is preferred because it will act reasonably quickly and will also evaporate off more readily than will cold water, facilitating the drying step following the contacting of the product with water. While cold water may be used, cold water will take longer to evaporate off the product, and is therefore somewhat less preferred. Thus, water of about 50-150° F. is preferred, with water of about 60-125° F. being more preferred and water of about 70 to about 100° F. being most preferred.

Drying Products to their Original Water Content

Once the flake, chip, other cereal product, potato chip, or freeze-dried food has been wetted, it is desirable to start drying it back to its original water content. The particular method of drying is not critical. If desired, drying can be performed simply by letting the cereal product, chip, potato chip, or freeze-dried food air dry. For example, the chip or product can be placed on a wire rack so that it is exposed to the air on all sides. Usually, though, it will be more convenient to assist the drying process. For example, the chip, product, or freeze-dried food can be placed on a conveyor belt that carries the wetted product into and through an air stream, which may further be heated to speed drying. A drying oven may be used for even faster drying. In general, the product should be dried to the desired water content for packaging. This will often be approximately the water content that the product had before the wetting step of the invention.

In a preferred method of the invention, the cereal product, chip, or freeze-dried food is on a wire or mesh conveyor belt. The product, chip, or freeze-dried food is sprayed with water from both top and bottom, wetting the cereal, chip, , or freeze-dried food, and the belt then carries the item into a drier, such as a tunnel drier, where it is contacted with heated air.

Nuts

In general, the art has taught that nuts should not be contacted with water because it is thought to promote development of rancidity. Surprisingly, it has now been found that contacting nuts with water delays the development of rancidity, thereby extending shelf life.

Following exposure to air, nuts undergo a so-called induction period. The end of the induction period is denoted by a marked increase in production of oxidation products of oils present in the nut. This period until the end of the induction period can conveniently be considered as the shelf life of the nut. While shelf life can be determined by any convenient means, food scientists often use a particular degradation product, hexanal, as a marker for oxidation of nut oils. Hexanal, which is a major breakdown product of the linoleic acid oxidation (Frankel E N, Prog. Lipid Res., 22:1-33 (1982)), has been shown to be a good indicator of oxidative rancidity in peanuts (Mate et al., J. Agric. Food Chem., 44:1736-1740 (1996)). Volatiles such as hexanal can be detected by various assay formats known in the art. In a preferred embodiment, the assay format is static headspace gas chromatography. Samples of the nut under study are taken at various points in time and ground to a powder to provide increased surface area and thereby release any volatile degradation products. Volatile degradation products for other nuts are known in the art. If the nut of interest is one other than peanut, the assay can be used to detect the presence of a volatile degradation product known to be produced by the nut of interest.

The invention is particularly useful with regard to peanuts. Although scientifically the peanut is classified as a legume, in the mind of the public, it is considered a nut. Indeed, commercially sold containers of “mixed nuts” typically contain peanuts as the predominant “nut” present. Studies on peanuts have shown that contacting a peanut with water and then drying it results in a marked extension of shelf life. Without wishing to be bound by theory, it is believed that the surface of the peanut has pores that permit air access below the surface of the peanut and that the presence of water causes the surface around the pores to expand, collapsing the pores, thereby rendering the surface of the nut less permeable to air. References below to nuts include peanuts unless otherwise specified. The invention is applicable to all types of nuts, such as pecans, almonds, cashews, walnuts, Brazil nuts, macadamia nuts, hazel nuts, and filberts.

The contacting of the nut with the water should be sufficient in a time and amount of water to hydrate the nut. Nuts are less sensitive to hydration than are cereals, as they tend to absorb little water. Thus, the amount of water used can be, for example, as little as 50 g for 6000 g of peanuts, and there is effectively no upper limit. In the Examples, below, satisfactory results were obtained using 500 g of water to treat 6000 g of peanuts.

The method of applying water is not critical and can be accomplished by any convenient means, such as by spraying, pouring, or ladling. The nuts can also be immersed in water, and can be left to soak. The nuts can be contacted with the water for as little as a few seconds and as long as one to two hours. Periods of contacting of longer than 30 minutes are, however, less preferred. Longer exposures may hydrate below the surface of the nut and lengthen the period of time necessary to dry the nut back to its original water content. Thus, it is desirable to contact the nut with water for a period sufficient to cause the collapse of the surface pores, but not so long as to prolong drying of the nut by more than 100% compared to a nut soaked for 1 minute. In preferred embodiments, the nut is contacted with water for a period between 2 seconds and 20 minutes. In more preferred embodiments, the nut is contacted with water for between 5 seconds and 10 minutes, and in even more preferred forms, between about 10 seconds and 5 minutes. It is not anticipated, however, that even with lengthy immersion the nut will absorb so much water that it will not dry in a period short enough to be suitable to for use in the methods of the invention.

In general, water of any temperature can be used, as can steam. In most applications, however, it will not be intended that the nuts be boiled or cooked by the contacting process, so if steam or very hot water is used, the contacting should be shortened accordingly. In general, cool to warm water is preferred, with warm water being more preferred. In preferred embodiments, the water temperature is between about 50 to 150° F., with temperatures of about 60-125° F. being more preferred and temperatures of about 70 to 100° F. being the most preferred.

The contacting step may be performed after the nut is otherwise prepared for packaging: that is, it is shelled and cooked (if the nut is typically roasted or otherwise cooked prior to packaging). If the nut is cooked or otherwise heated prior to packaging, the nut can conveniently be contacted with water after coming out of the roasting or cooking step. Any residual heat in the nuts can then aid in speeding the evaporation of the water following the contact and facilitate drying of the nuts. If the nut has a skin, it is preferred if the skin is removed prior to contacting the nut with the water since that facilitates the contacting with water.

In preferred embodiments, the nut is subjected to mild abrasion during the contacting with water. Because of the oil content of nuts, water has a tendency to “bead” on the surface, and abrasion facilitates the spreading of water over the nut's surface and rewets it. Desirably, the abrasion is not so great as to damage the nut or to reduce the attractiveness of its appearance. Conveniently, the abrasion can be provided by rolling the nut in a container (for example, by rotating or by vibrating the container) or by contacting the nut with other nuts, either of the same type or of other types, and then causing them to move relative to one another. This can be caused by any convenient means, such as by placing nuts in a container and then jostling, vibrating or rotating the container.

Alternatively, the nuts can be placed in a container with water and mechanical action or agitation added to move the nuts in the container and bring them into contact with one another. For example, the nuts can be stirred with a stirring rod or a mechanical agitator. In a preferred embodiment, the nuts and water are placed in a confectionery “pan” (a stainless steel drum which resembles a cement mixer) and the drum of the pan rotated. Nuts with a round or oval configuration are easily contacted with water in this way for 20 seconds up to several minutes. Nuts with shapes which make it harder to contact the entire surface easily (such as cashew, which have an interior curve which is a little less accessible, or nuts with grooves or other indentations which are harder to reach, such as walnuts) should be subjected to the agitation for a longer period, preferably from a minute to several minutes, to facilitate more even contacting with the water. It is anticipated that the contacting will still retard overall degradation of the nut even if less than 100% of the surface is subjected to abrasion.

The particular method of drying the nuts is not critical. For example, the nuts can be air dried, room air can be blown on them, heated air can be blown on them, or the nuts can be passaged through a tunnel drier, and the time can be as much as necessary to return to their original water content.

### EXAMPLES

### Example 1

Studies of the effect of water on nuts were conducted using ˜500 g of water per 6000 g of peanuts. Water was ladled onto peanuts in a confectionery “pan” and the pan was rapidly tumbled for ˜20 seconds, The nuts were then dried by blowing air into the pan for ˜25 minutes. Peanuts were dried on one surface of the stationary bed, flipped to be dried on the other side, and then flipped again several times.

### Example 2

Detection of hexanal was performed on a Perkin-Elmer gas chromatograph (GC) autosystem with HS-40 autosampler (Norwalk, Conn.). The GC analysis used a capillary DB-1701 column (30 m (1)×0.32 mm (I.D.), 1 mm thickness, J & W, Folsom, Calif.); at the following settings: HS sampler temperature, 60° C.; oven temperature, 65° C.; injector temperature, 180° C.; detector temperature, 200° C. For the assay, 5g of sample was ground for 8 seconds using a Braun coffee bean grinder, model KSM2(4), Braun Inc., (Woburn, Mass.).

It is understood that the examples and embodiments described herein are for illustrative purposes only and that various modifications or changes in light thereof will be suggested to persons skilled in the art and are to be included within the spirit and purview of this application and scope of the appended claims. All references cited herein, including journal articles, books, and abstracts, published or corresponding U.S. or foreign patent applications, issued U.S. or foreign patents, and any other references, are incorporated by reference herein, including all data, tables, figures, and text presented in the cited references.

What is claimed is:

1. A method for improving a cereal product, said method comprising
(a) contacting said cereal product with substantially pure water or with steam, and
(b) drying said cereal product to its original water content,
thereby improving reducing the cereal product.

2. A method of claim 1, wherein said contacting is by spraying water on said cereal product.

3. A method of claim 1, wherein said contacting is by misting said cereal product with water.

4. A method of claim 1, wherein said water is at least about 90% pure.

5. A method of claim 1, wherein said water is between about 50 and about 150° F.

6. A method of claim 1, wherein said water is between about 70 and about 100° F.

7. A method of claim 1, wherein said cereal product is a ready-to-eat breakfast cereal.

8. A method of claim 8, wherein said ready-to-eat breakfast cereal is a flaked cereal.

9. A method of claim 9, wherein said flaked cereal is selected from the group consisting of a corn flake, a wheat flake, an oat flake, a barley flake, and a rice flake.

10. A method of claim 1, wherein said cereal product is a fried or baked cereal chip.

11. A method of claim 10, wherein said fried or baked cereal chip is a corn chip.

12. A method of claim 10, wherein said fried or baked cereal chip is a tortilla chip.

13. A method of claim 1, wherein the improvement is an increase in bowl life of a ready-to-eat (“RTE”) breakfast cereal.

14. A method of claim 13, wherein said RTE cereal is selected from a flake, an extruded cereal piece, and a nugget.

15. A method of claim 14, wherein said RTE cereal is a flake.

16. A method for reducing the friability of a potato chip or of freeze-dried food, said method comprising
(a) contacting said potato chip or freeze-dried food with water, and
(b) drying said potato chip or freeze-dried food to its original water content,
thereby reducing its friability.

17. A method of claim 16, wherein said contacting is by spraying water on said potato chip or freeze-dried food.

18. A method of claim 16, wherein said contacting is by misting said potato chip or freeze-dried food with water.

19. A method of claim 16, wherein said water is between about 50 and about 150° F.

20. A method of claim 16, wherein said water is between about 70 and about 100° F.

21. A method for increasing shelf life of a nut, said method comprising
(a) contacting said nut with water, and
(b) drying said nut to its original water content,
thereby increasing its shelf life.

22. A method of claim 21, wherein said contacting is by spraying water on said nut.

23. A method of claim 21, wherein said contacting is by immersing said nut in water.

24. A method of claim 21, wherein said contacting is by pouring water over said nut.

25. A method of claim 21, further comprising subjecting said nut to light abrasion in the presence of said water.

26. A method of claim 25, wherein said mild abrasion is caused by contacting said nut with a second nut.

27. A method of claim 26, wherein said nut is moved against said second nut by placing said nuts in a movable container and moving said container.

28. A method of claim 26, wherein said nut is moved against said second nut by placing said nuts on a surface and agitating the nuts.

29. A method of claim 26, wherein said nut and said second nut are of different types.

30. A method of claim 21, wherein said nut is a peanut.

31. A method of claim 21, wherein said nut is selected from the group consisting of almond, cashew, walnut, hazelnut, pecan, macadamia, pistachio, Brazil nut, and filbert.
